(19) United States
(12) Patent Application Publication
(10) Pub. No.: US 2001/0014894 A1
(43) Pub. Date: Aug. 16, 2001

(54) File managing method for a digital data stream

(76) Inventors: Seog Yeon Han, Kyunggi-do (KR); Seung Hoon Lee, Kyunggi-do (KR); Kang-Soo Seo, Kyunggi-do (KR); Soung-Hyun Um, Kyunggi-do (KR)

Correspondence Address: BIRCH STEWART KOLASCH & BIRCH, PO BOX 747, FALLS CHURCH, VA, 22040-0747, US

(21) Appl. No.: 09/779,556

(22) Filed: Feb. 9, 2001

(30) Foreign Application Priority Data
Feb. 11, 2000 (KR) 00-06479
Feb. 11, 2000 (KR) 00-06483
Mar. 17, 2000 (KR) 00-13669
Mar. 20, 2000 (KR) 00-14120

(51) Int. Cl. G06F 17/30

(52) U.S. Cl. 707/202; 707/200

(57) ABSTRACT

The present invention relates to a file management method of digital data stream recorded or to be record in a rewritable disk. A file management method checks file names and directories of files written in the rewritable disk, and outputs a message indicating that reproduction is impossible when the file names and directories do not conform to the standard file scheme pre-specified for a disk containing real-time data file. Another file management method checks a file name and directory of a file requested to be recorded in the rewritable disk, and outputs a message indicating that reproduction would fail later if recorded as requested when the file name and/or the directory is against the standard file scheme.

### BACKGROUND OF THE INVENTION

1. Field of the Invention

The present invention relates to a file management method of informing that file name or directory change will make it impossible to reproduce real-time data files which are recorded in a disk recording medium such as a rewritable digital versatile disk (DVD).

2. Description of the Related Art

FIG. 1 shows partial elements of an optical device such as a video disk recorder which recording and reproducing a signal to/from a disk recording medium such as a rewritable DVD. The device configured as FIG. 1 comprises an optical pickup 2 reading a signal recorded in a rewritable DVD 1 or writing a data stream processed into a writable signal in the rewritable DVD 1; a VDR unit 3 processing the read signal to restore to original data and converting an inputted data stream into a signal adequate to be written; and an encoder 4 encoding a received analog signal into a data stream which is sent to the VDR (Video Disk Recording) unit 3.

Disk file management method conducted by the optical device connected with a personal computer (PC) through a digital interface is explained referring to the accompanying drawings.

Various types of data files are recorded in the rewritable DVD 1 and the data files consist of data stream files and information files. The data stream files contain text data or real time audio and video (A/V) data of large size and the information files contain control information such as navigation data for the A/V or text data contained in the data stream files.

To manage recorded files, a rewritable DVD may adopt fixed file structure, which is adopted for a DVD ROM disk, composed of a root directory, several title set directories located under the root, and data files having different names and extension located under each title set directory.

FIG. 2 shows an example of such a fixed file structure in which a video title set directory under a root directory has several data files having different extension names.

Under the video title set directory, many files of ‘Video_TS.IFO’, ‘Video_TS.VOB’, ‘Video_TS.BUP’, ‘VTS_{—}01_{—}0.IFO’, ‘VTS_{—}01_{—}1.VOB’, ‘VTS_{—}01_{—}2.VOB’, and ‘VTS_{—}01_{—}0.BUP’ have been recorded. The file ‘Video_TS.IFO’ contains video data management information, the file ‘Video_TS.VOB’ contains menu data of a recorded video object (VOB), the file ‘Video_TS.BUP’ contains backup data for the video data management information, the file ‘VTS_{—}01_{—}0.IFO’ contains information on the first video title set, the file ‘VTS_{—}01_{—}1.VOB’ is the first video object containing A/V data belonging to the first video title set, the file ‘VTS_{—}01_{—}2.VOB’ is the second video object containing A/V data belonging to the first video title set, and the file ‘VTS_{—}01_{—}0.BUP’ contains backup information on the first video title set.

To manage recorded files, a rewritable DVD may adopt other fixed file system, which is composed of a root directory, an A/V directory pre-defined as ‘DVD_RTAV’ under the root, and data files having different pre-defined names and type-dependent extension names under the predefined A/V directory.

FIG. 3 shows another example of such a fixed file system in which an A/V directory ‘DVD_RTAV’ under a root directory has several data files, each having pre-defined file name. Under the directory ‘DVD_RTAV’, four files of ‘VR_MANAGER.IFO’, ‘VR_MOVIE.VRO’, ‘VR_STILL.VRO’, and ‘VR_AUDIO.VRO’ are recorded. The file ‘VR_MANAGER.IFO’ contains navigation information for real-time data stream written in the other ‘VRO’ files, the file ‘VR_MOVIE.VRO’ contains data stream of moving pictures, the file ‘VR_STILL.VRO’ contains data of still pictures, and the file ‘VR_AUDIO.VRO’ contains audio data stream.

Detailed information for each of the above files hierarchically-structured as FIG. 2 is written in a file identifier descriptor (FID) whose fields are shown in FIG. 4A. These fields are ‘Descriptor Tag’, ‘File Version Number’, ‘File Characteristics’, ‘Length of File Identifier’, ‘Information Control Block (ICB)’, ‘Length of Implementation Use’, ‘Implementation Use’, ‘Name of File Identifier’, and padding. Among these fields, ‘Name of File Identifier’ field is used for writing a string indicative of a file name, ‘Length of File Identifier’ field is used for writing size information of the file name, and ‘File Characteristics’ field, whose size is 1 byte, is used for writing various attributes of the file. The attributes written in ‘File Characteristics’ field are shown in FIG. 4B. The first LSB (Least Significant Bit) indicates whether an associated file exists or not, the second LSB indicates whether the file is directory or file, the third indicates deletion of the file, the fourth indicates whether the directory is parent or not, the fifth indicates meta data, and the remaining bits are reserved for future use.

If the first title set recorded in the rewritable DVD 1 having the above file structure is requested to be reproduced after the rewritable DVD 1 is inserted in the optical disk device of FIG. 1, the VDR unit 3 searches the DVD 1 for video title set directory under the root directory, and tries to read the several files under the video title set directory. To read data files and their management file belonging to the first video title set requested to be reproduced, the VDR unit 3 refers to information written in FID. The VDR unit 3 reads data files sequentially after searching them using navigation information written in the management file.

The disk device of FIG. 1 may be connected a personal computer (PC) through a digital interface, so that a user might request file name of a file recorded in the rewritable DVD 1 to be changed into a desirable name through the PC and the digital interface. In addition, a user might move one or more files under a video title set directory to other directory.

Such changes of file name and directory might be directly conducted with a PC after a rewritable DVD is placed in the PC.

However, the VDR unit 3 searches a rewritable DVD for pre-specified file names under pre-specified directory, which satisfy the file structure shown in FIG. 2 or 3, according to a playback-requested video title set or A/V data stream, therefore, the VDR unit 3 could not determine which file to read if the file or directory names have been changed or files have been moved to other directories through a command from a connected PC to the disk device or a direct operation of a PC, so that it could not reproduce a playback-requested video title set.

### SUMMARY OF THE INVENTION

It is an object of the present invention to provide a file management method checking whether or not file names and their directory schemes are normal and informing that real-time data files can not be reproduced based on the checked result.

It is another object of the present invention to provide a file management method checking whether or not the present file structure drawn up in a rewritable disk conforms to standard file system, and correcting the present file structure if it is against the standard pre-defined for a rewritable disk containing real-time data stream.

It is another object of the present invention to provide a file management method of a PC operating system (OS) for informing that later reproduction of a rewritable disk would fail if one or more specific files written in the rewritable disk is to be renamed or moved to other directory.

A file management method according to the present invention checks file names and directories of files written in a rewritable disk when real-time data contained in the files is requested to be reproduced, and outputs a message indicating that later reproduction would be impossible when the file names and directories do not conform to the standard file scheme pre-specified for a disk containing real-time data file.

Another file management method according to the present invention checks a file name and directory of a file requested to be recorded in a rewritable disk, and outputs a message indicating that later reproduction would fail if recorded as requested when the file name and/or the directory does not conform to the standard file scheme pre-specified for a disk containing real-time data file.

Another file management method according to the present invention checks the file structure of a rewritable disk before recording data if data is requested to be recorded, and corrects file or directory name which is against standard name and preserves old file structure at the same time.

Another file management method conducted in a PC operating system according to the present invention checks the type of a file if the file is requested to be renamed or moved, and outputs a message informing that later reproduction of a rewritable disk would fail if the requested operation is conducted if the file type is indicative of real-time data file.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 shows partial elements of an optical disk device such as a video disk recorder which recording and reproducing a signal to/from a disk recording medium such as a rewritable DVD;

FIG. 2 is an example of a fixed file system for a rewritable disk;

FIG. 3 is another example of a fixed file system for a rewritable disk;

FIGS. 4A and 4B show a format of file identifier descriptor and its attribute fields, respectively;

FIGS. 5A to 5D are examples of wrong file scheme caused from file movement, file or directory renaming;

FIG. 6 is a flow diagram of a file management method for a recorded digital stream according to the present invention;

FIG. 7 is a flow diagram of another file management method for a digital stream to be recorded according to the present invention;

FIG. 8 is a simplified block diagram of a personal computer which another file management method according to the present invention is applied to;

FIGS. 9A and 9B are syntax of a file entry and its field of ICB tag;

FIG. 10 is a table showing various file types;

FIG. 11 is a flow diagram of another file management method according to the present invention;

FIG. 12. a flow diagram of another file management method according to the present invention;

FIG. 13 is an example of a wrong file structure caused from non-standard file name;

FIG. 14 is an example of a pop-up window showing the message indicative of wrong file structure;

FIG. 15 is an example of corrected file structure; and

FIG. 16 is an example of a message window provided when there is no essential file.

### DETAILED DESCRIPTION OF THE PREFFERRED EMBODIMENTS

In order that the invention may be fully understood, preferred embodiments thereof will now be described with reference to the accompanying drawings.

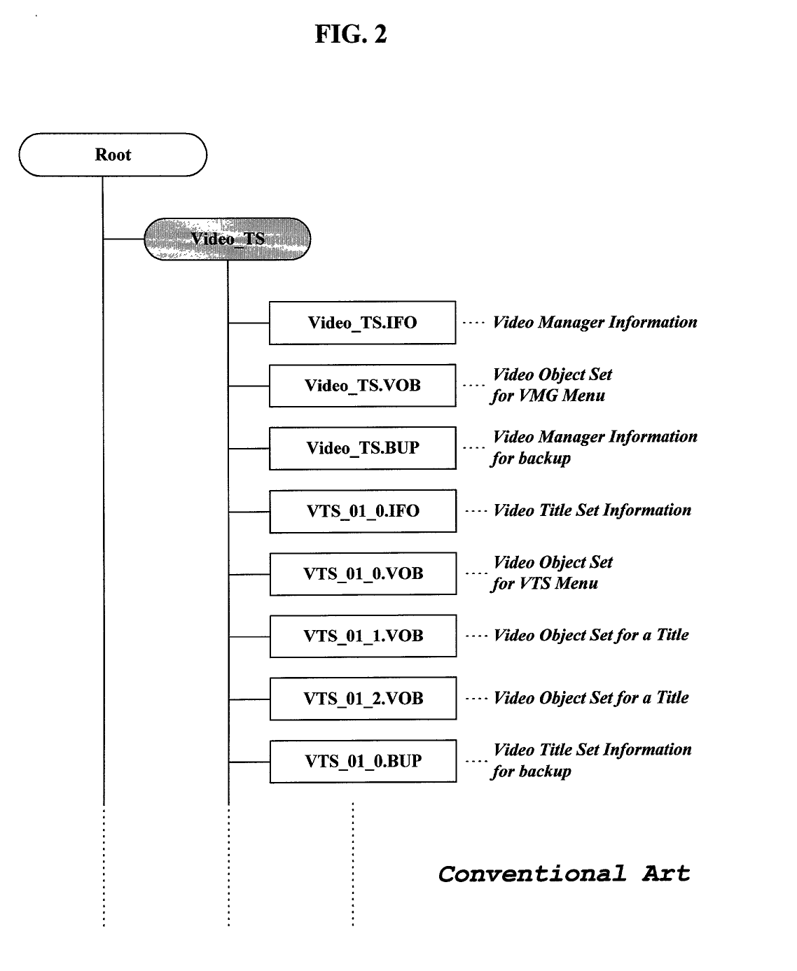

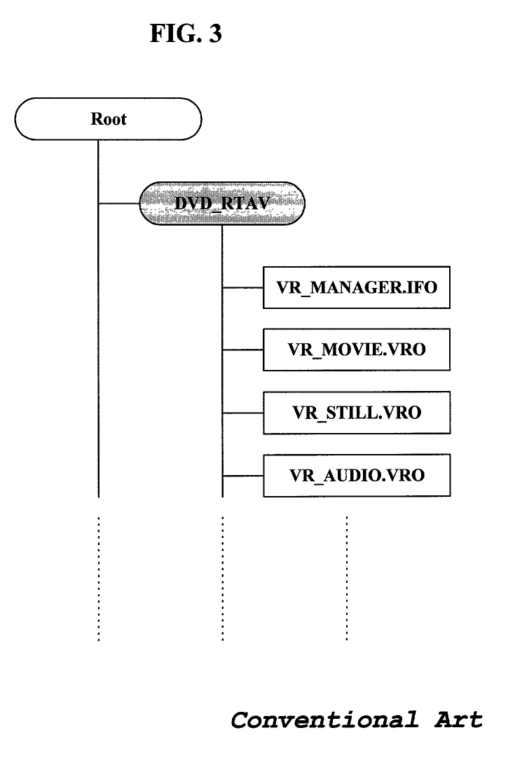

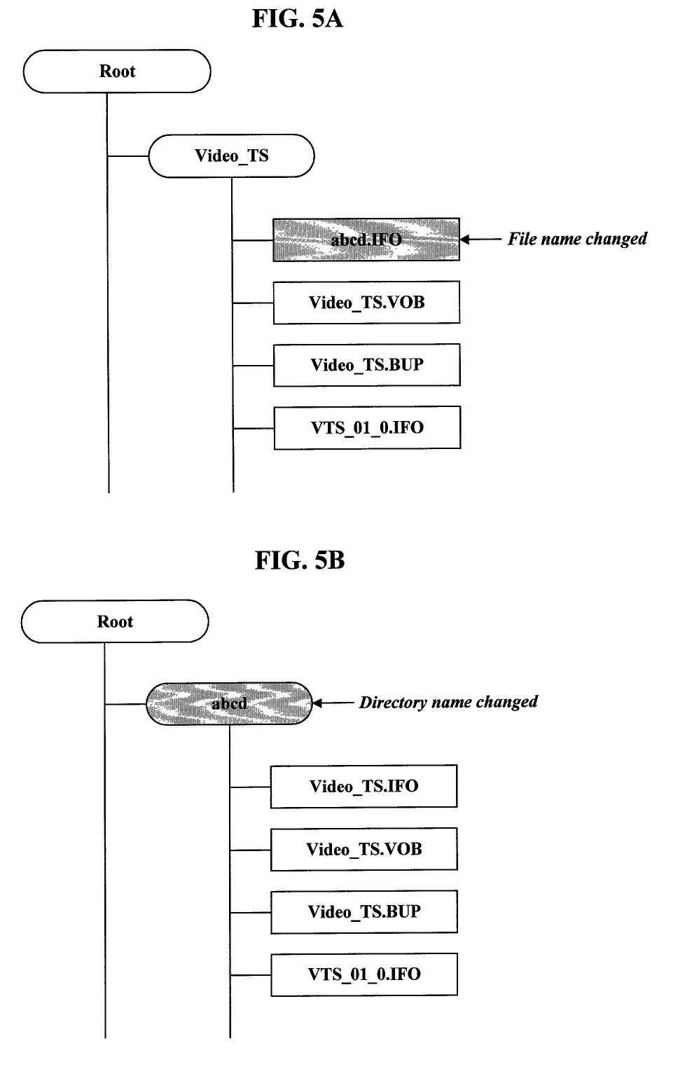

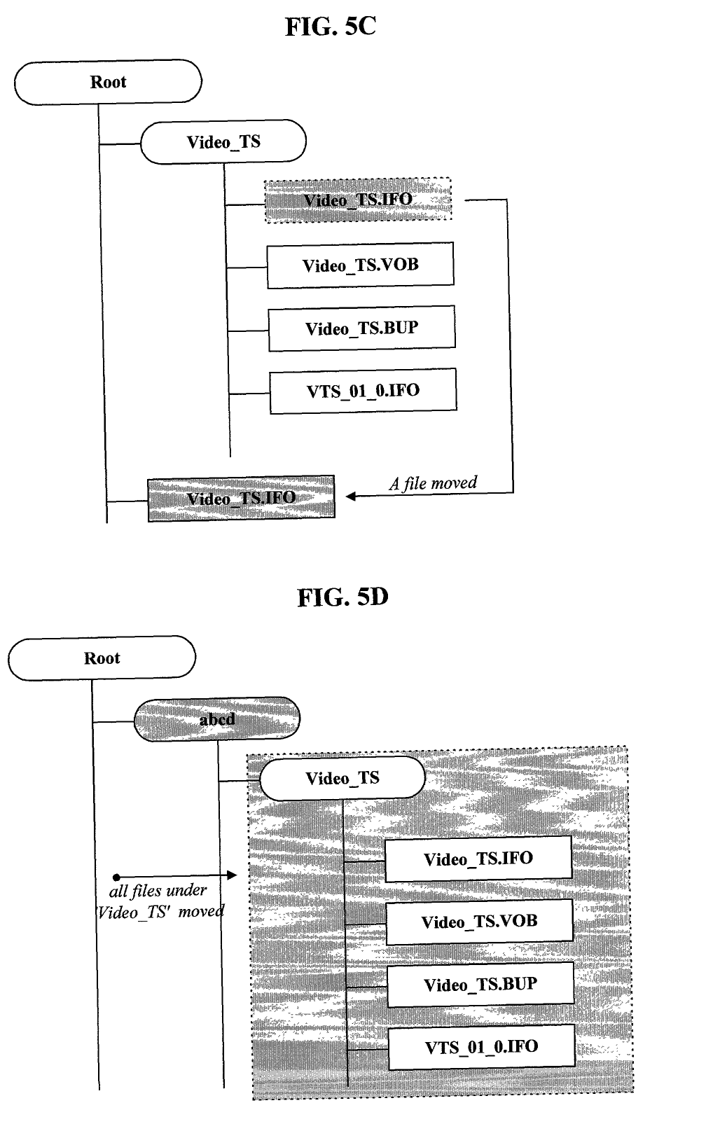

FIGS. 5A and 5B show examples that file name or directory of a certain file has been changed from the file structure of a rewritable DVD depicted in FIG. 2. In the example of FIG. 5A, the name of ‘Video_TS.IFO’ under a video title set directory has been changed to ‘abcd.IFO’, which does not belong to file names pre-specified in the standard fixed file structure of a rewritable DVD, through a PC. In the example of FIG. 5B, a video title set directory has been renamed to an arbitrary directory name ‘abcd’.

FIG. 5C shows another example that the file ‘Video_TS.IFO’ under a video title set directory has been moved to root directory, which is not proper directory under which the information file of a video title set should exist, through a PC. FIG. 5D shows another example that all files under the root directory has been moved under an arbitrary directory ‘abcd’.

If a rewritable DVD having such a wrong file scheme as mentioned in FIGS. 5A to 5D is requested to be reproduced, the reproduction can not be conducted. The method informing a user about such a fail in reproduction is explained in detail hereinafter.

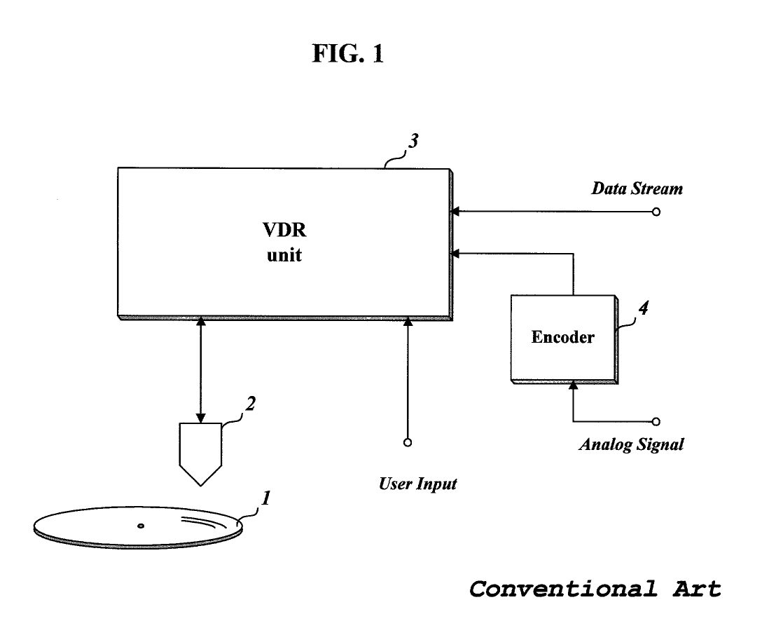

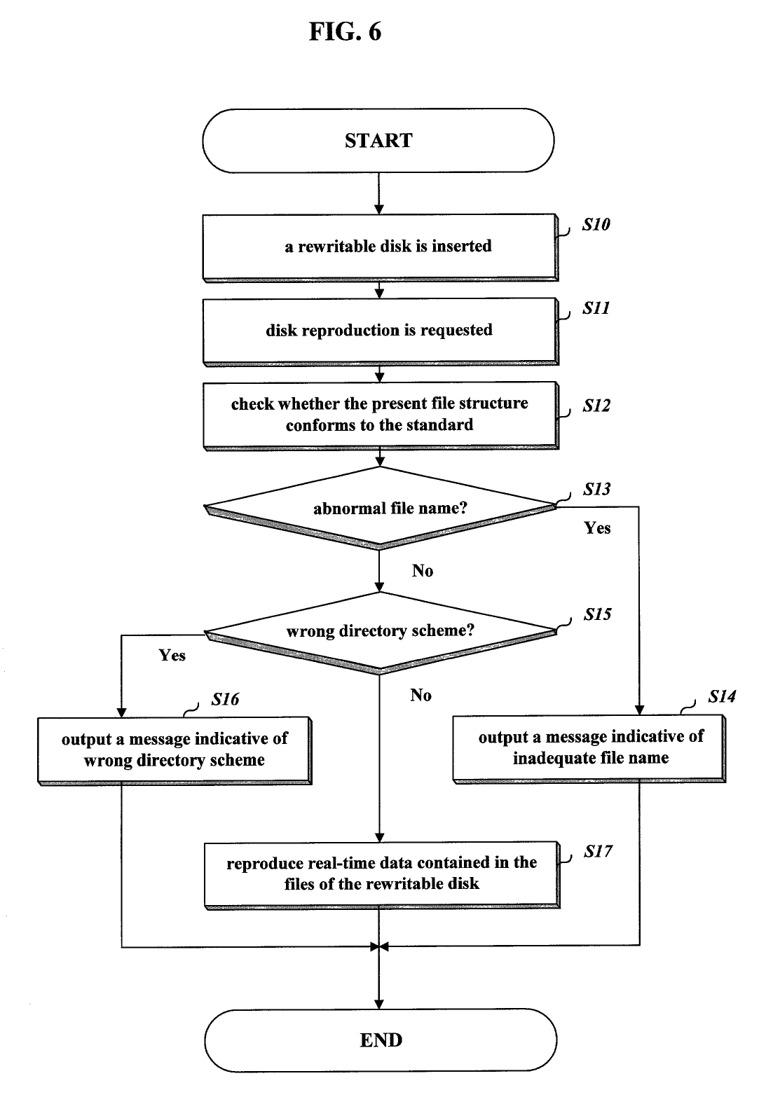

FIG. 6 is a flow chart embodying a file managing method for a recorded digital stream. The flow of FIG. 6 to inform of the reason why data reproduction of a rewritable DVD fails is described with reference to the disk device of FIG. 1.

A user inserts a rewritable DVD 1 containing real-time data stream files into the disk device (S10) and requests the DVD 1 to be reproduced (S11). Then, the VDR unit 3 checks the file scheme of the inserted DVD to know whether the present file structure is adequate to reproduce (S12).

If one among the written files has abnormal name (S13) which is contrary, as shown in FIG. 5A, to file name assigning rule which should be satisfied for a disk containing real-time data, the VDR unit 3 constructs a message informing that a file name is inadequate so that it is impossible to reproduce, and outputs the constructed message to be displayed (S14). Therefore, a user is notified of the reason of reproduction failure.

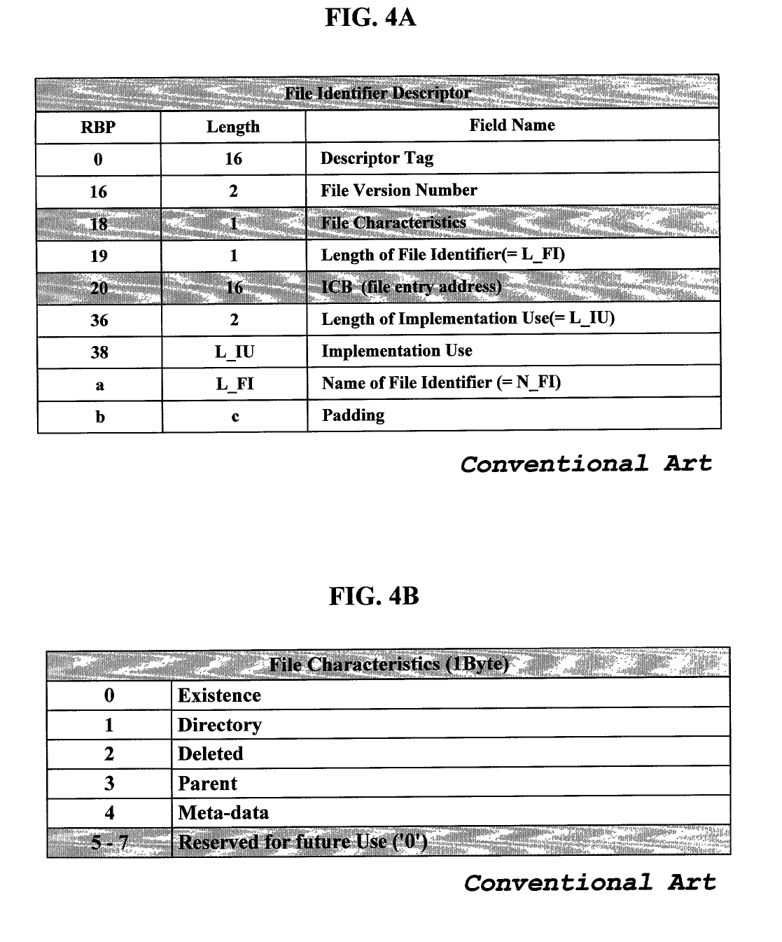

If one or more files are positioned under wrong or inadequate directory (S15) due to file movement or change of directory name as shown in FIG. 5B to 4D, the VDR unit 3 also constructs a message informing that the directory structure is messed up, and outputs the message to be displayed (S16). Therefore, a user is notified that the disk reproduction failed because of nonstandard directory structure or name.

If all files and directories are normal, that is, all files have pre-specified standard names satisfying the file name assigning rule and are positioned under pre-specified directories, the VDR unit 3 reproduces sequentially real-time data contained in the files ‘VTS_On_m.VOB’ s of the inserted rewritable DVD 1 (S17).

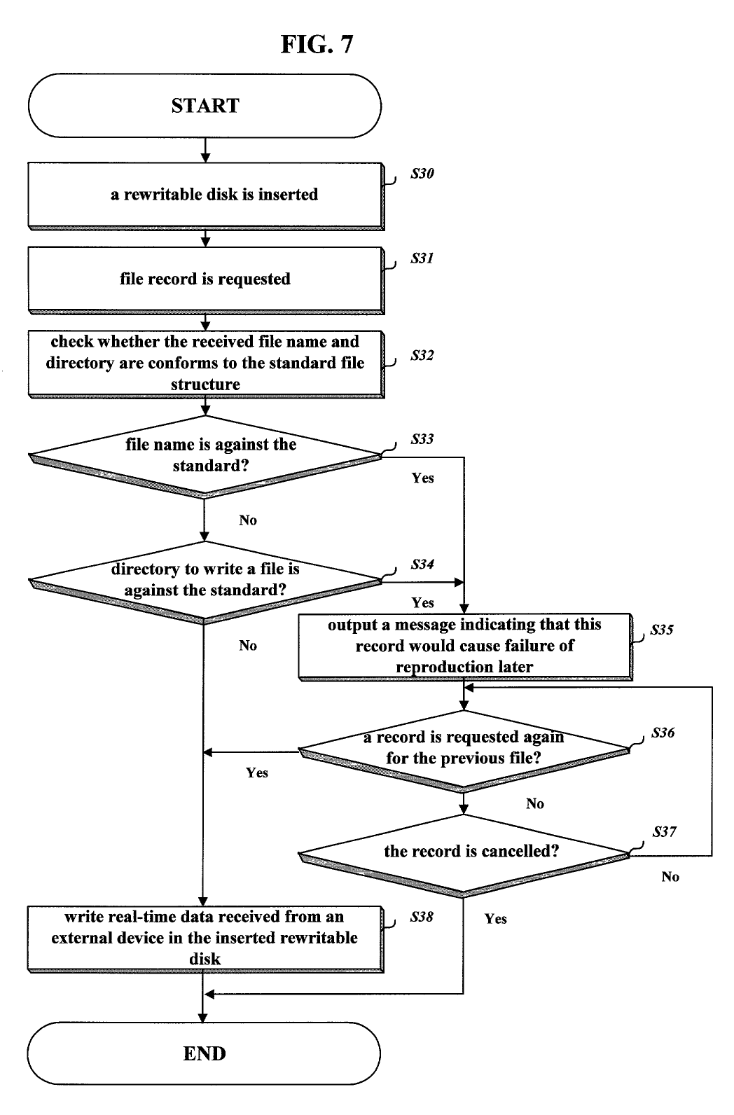

FIG. 7 is a flow chart embodying another file managing method for a digital stream to be recorded. The flow of FIG. 7 is to inform that recorded data will fail in reproduction since the name of record-requested file or directory to write the file under is against pre-specified standard rule.

A user inserts a rewritable DVD 1 into the disk device (S30) and requests a file containing real-time data stream to be recorded in the DVD 1 (S31). Then, the VDR unit 3 checks a file name and a directory assigned by a user to know whether the file name and the directory agree with pre-specified standard file structure (S32).

If the assigned file name or directory is against the standard rule of file name assignment and standard directory scheme specified for real-time data (S33,S34), the VDR unit 3 constructs a corresponding message informing that the assigned file name is inadequate or the directory to write the file under is wrong so that later reproduction would be impossible if recorded as requested, and outputs the constructed message to be displayed (S35). Therefore, a user is notified that the file name or directory is specified wrongly for a file containing real-time data.

After the message being outputted, if a user still wants to record the file as requested before (S36), the VDR unit 3 writes real-time data received from an external device in the inserted rewritable DVD 1 through the pickup 2 (S38). If a user cancels the requested record (S37), the VDR unit 3 deletes the record information such as file name and directory received before from its internal memory and stops record operation.

Hereinafter explained is another file management method conducted by a PC operating system (OS) when a file or a directory written in a rewritable DVD is requested to be renamed or moved.

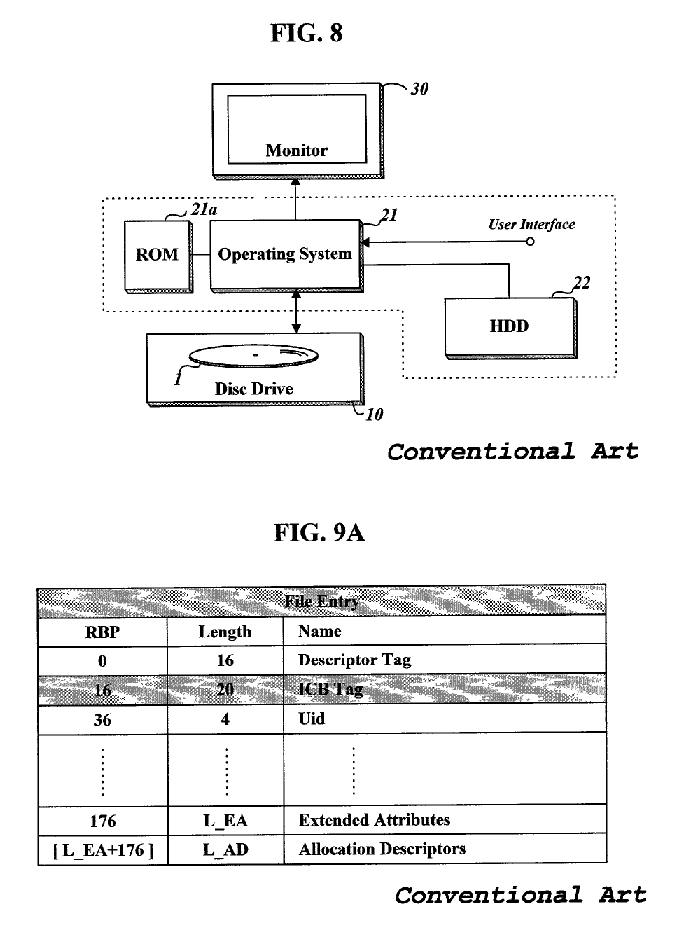

FIG. 8 is a simplified block diagram of a personal computer which the file management method according to the present invention is applied to.

An OS 21 of the PC reads management information for data files recorded in a rewritable DVD 1 when the DVD 1 is placed into a disk drive 10.

The OS 21 has information on one or more file types in a read-only memory (ROM) 21a. This file type information stored in the ROM 21a is used for deciding how to respond to the request of renaming or movement of a real-time data file from a user.

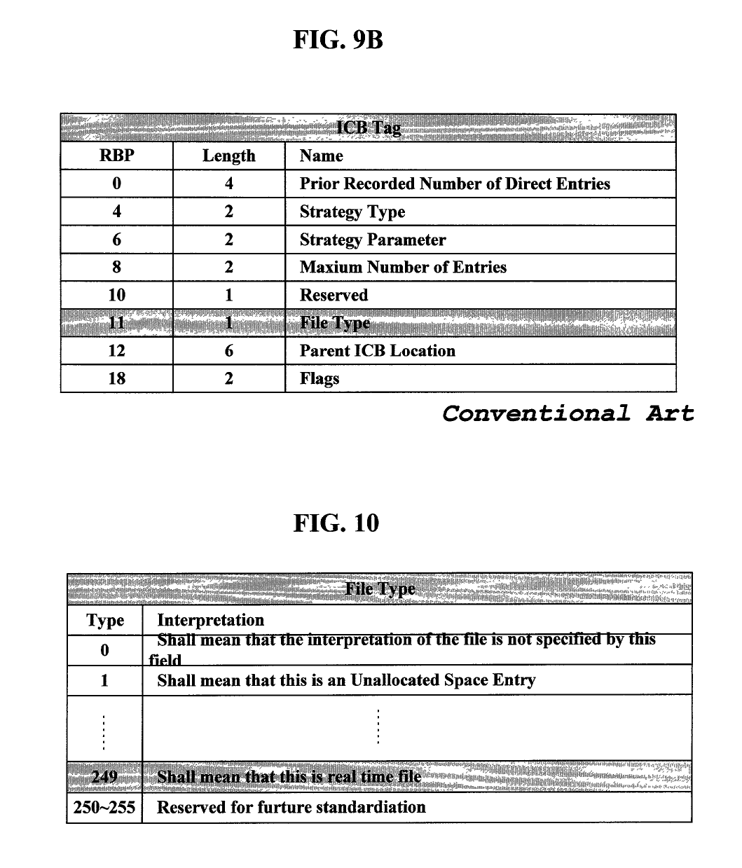

In the meantime, all information about files recorded in the rewritable DVD 1 is written in the hierarchically-structured tables shown in FIGS. 4A, 9A, and 9B.

A file identifier descriptor of FIG. 4A contains an information control block (ICB) to refer to obtain detailed information on a file. The ICB indicates an address of a file entry of FIG. 9A in which an ICB tag is contained. The ICB tag is composed as shown in FIG. 9B. A 1-byte field of file type is written in the ICB tag. There are various file types indicative of attribute of data contained in a file as given in the table of FIG. 10. A file type indicative of real-time data stream file is defined as number ‘249’ in this embodiment.

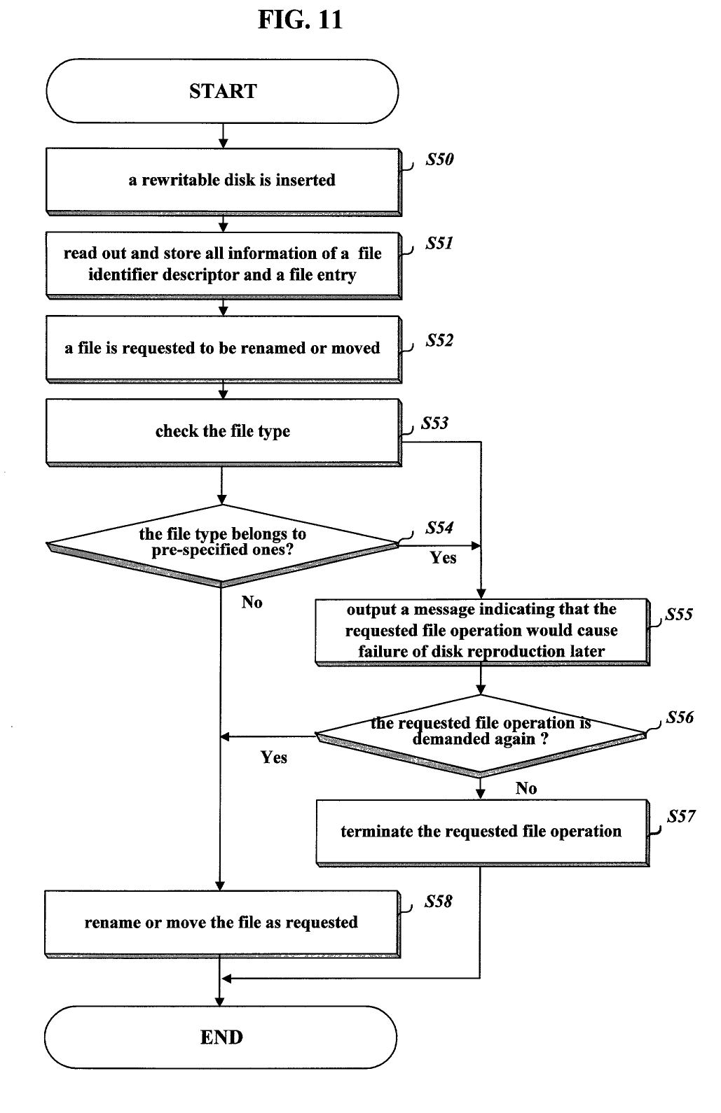

FIG. 11 is a flow chart embodying another file managing method conducted in the PC configured as FIG. 8. The flow diagram depicted in FIG. 11 is explained in detail.

When a rewritable DVD 1 is inserted in the disk drive 10 (S50), the OS 21 reads out all information such as the aforementioned file identifier descriptor and the file entry from the inserted DVD 1 and stores them (S51).

After that, if a file of the DVD 1 is requested to be renamed or moved (S52), the OS 21 checks the type of the requested file through referring to the stored information table of FIGS. 4A, 9A, and 9B (S53). If the type of the requested file is not one among the file types pre-stored in the ROM 21a (S54), for example, if the value indicative of file type is not 249, which is for real-time data stream, the OS 21 conducts the requested operation for the file, that is, file renaming or file moving operation (S58).

If the type is one among the file types memorized in the ROM 21a, the OS 21 checks the responding action specified for that type in the ROM 21a for the requested operation. If the specified action is indicative of ‘forbidden’, the OS 21 stops the requested file operation unconditionally. If the specified action is indicative of ‘warning’, the OS 21 constructs a message informing that later reproduction of the DVD 1 might be impossible if the file operation is conducted as requested, and then outputs the constructed message onto a monitor 30 (S55). Through this warning message, a user is notified that the requested operation is so much important that it would cause a fatal result in the disk reproduction.

After the message being outputted, if a user still wants the requested file operation to be conducted (S56), the OS 21 renames or moves the file as a user requested (S58). If a user cancels the requested operation, the OS 21 deletes the information such as file and/or directory name received before and terminates the file operation (S57).

In order to restrain file operations, file names may be used instead of file types. For this embodiment, file names defined in a standard file system specified for a disk containing real-time data stream files are pre-stored in the ROM 21a instead of file types. Therefore, when a file is requested to be renamed or moved, its name is compared with file names pre-stored in the ROM 21a. Then, if the name of the requested file is one among the names memorized in the ROM 21a, the requested file operation is forbidden or warned as described above.

In the embodiments conducted in a PC, if a directory is requested to be renamed from a user, the OS 21 checks all files under the requested directory to know whether the type or name of at least one file belongs to the types or names memorized in the ROM 21a. If the type or name is pre-stored in the ROM 21a, the OS 21a restrains the name of directory, which contains at least one real-time data stream file, from being changed through warning that the requested operation might cause fatal error in later disk reproduction.

Hereinafter explained is another file management method conducted in the disk device configured as FIG. 1 when data is requested to be recorded in a rewritable disk.

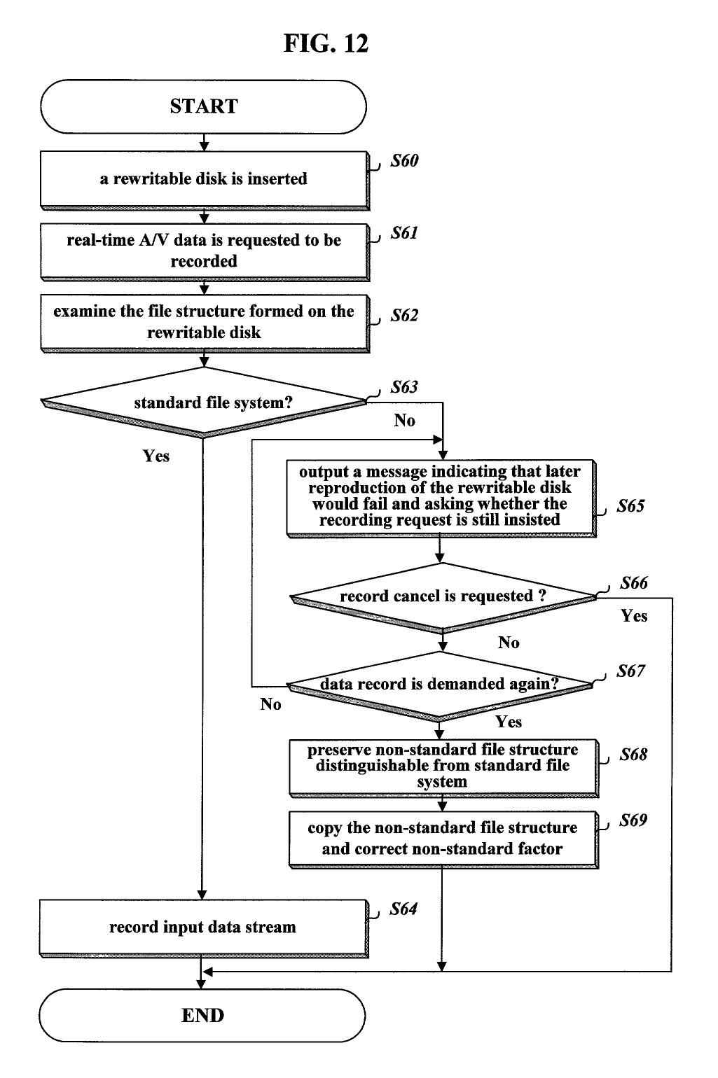

FIG. 12 is a flow diagram which checks file structure recorded in a rewritable disk when data record is requested, and corrects the file structure if it is against standard file system. In this embodiment of the present invention, it is supposed that a rewritable disk has adopted the standard file system shown in FIG. 4.

According to the flow of FIG. 12, if a rewritable disk is inserted into the disk device of FIG. 1 (S60) and is requested to record real-time A/V data stream (S61), the VDR unit 3 examines the file structure formed on the rewritable disk (S62) before recording input data stream. If the written files and directories conform to standard file system pre-defined for A/V data recording disk (S63), the VDR unit 3 records input data stream in an appropriate file of the rewritable disk according to the attribute of input data stream (S64).

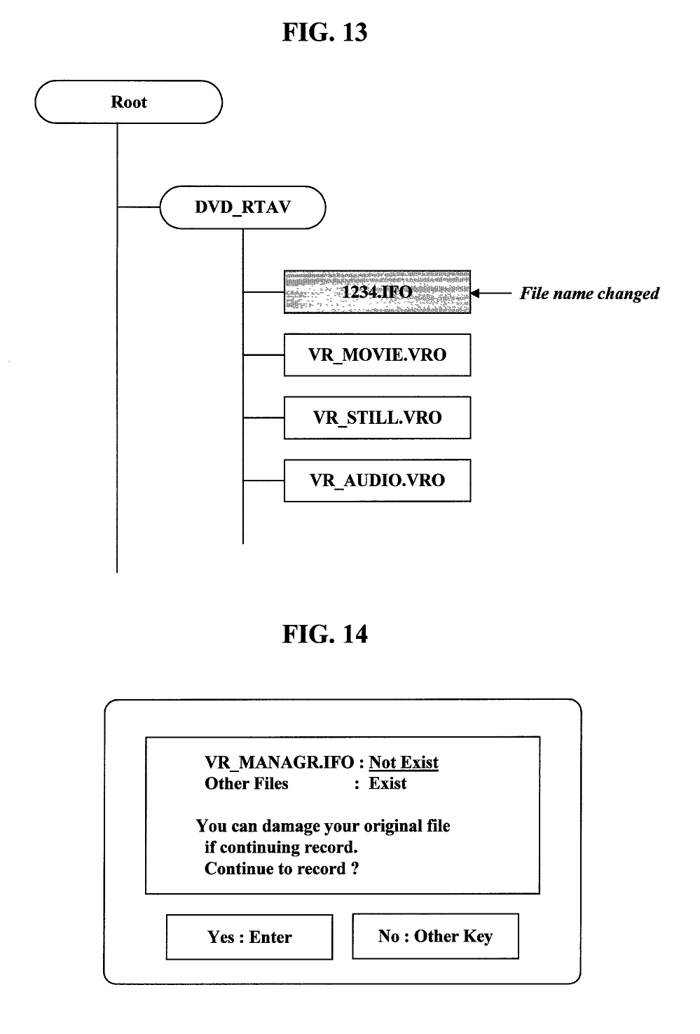

If not, for example, if pre-defined file ‘VR_MANAGER.IFO’ has been renamed to ‘1234.IFO’ with a PC as shown in FIG. 13, the VDR unit 3 constructs a message indicating that later reproduction of the rewritable disk would fail after the requested record is done and asking whether the recording request is still insisted nevertheless, and outputs the message to be displayed (S65). FIG. 14 is an example of a pop-up window showing the message.

If the requested record is cancelled from a user after the message is displayed (S66), the VDR unit 3 terminates a record preparing operation, however, if data record is still demanded (S67), the VDR unit 3 renames the directory ‘DVD_RTAV’ containing the file ‘1234.IFO’ whose name is non-standard to nonstandard directory name, for example, ‘DVD_RTAV1’ (S68).

Then, the VDR unit 3 creates new directory whose name conforms to standard file scheme, that is, ‘DVD_RTAV’, copies all files under the renamed directory ‘DVD RTAV1’ into the created standard directory ‘DVD_RTAV’, and changes the wrong file name ‘1234.IFO’ under the ‘DVD RTAV’ into ‘VR_MANAGER.IFO’ to be conformed to standard file system (S69). After this correction, the VDR unit 3 writes input data stream in the file ‘VR_MOVIE.VRO’, ‘VR_AUDIO.VRO’, or ‘VR_STILL.VRO’, and updates the navigation information of the file ‘VR_MANAGER.IFO’ to reflect changed information caused from the data recording.

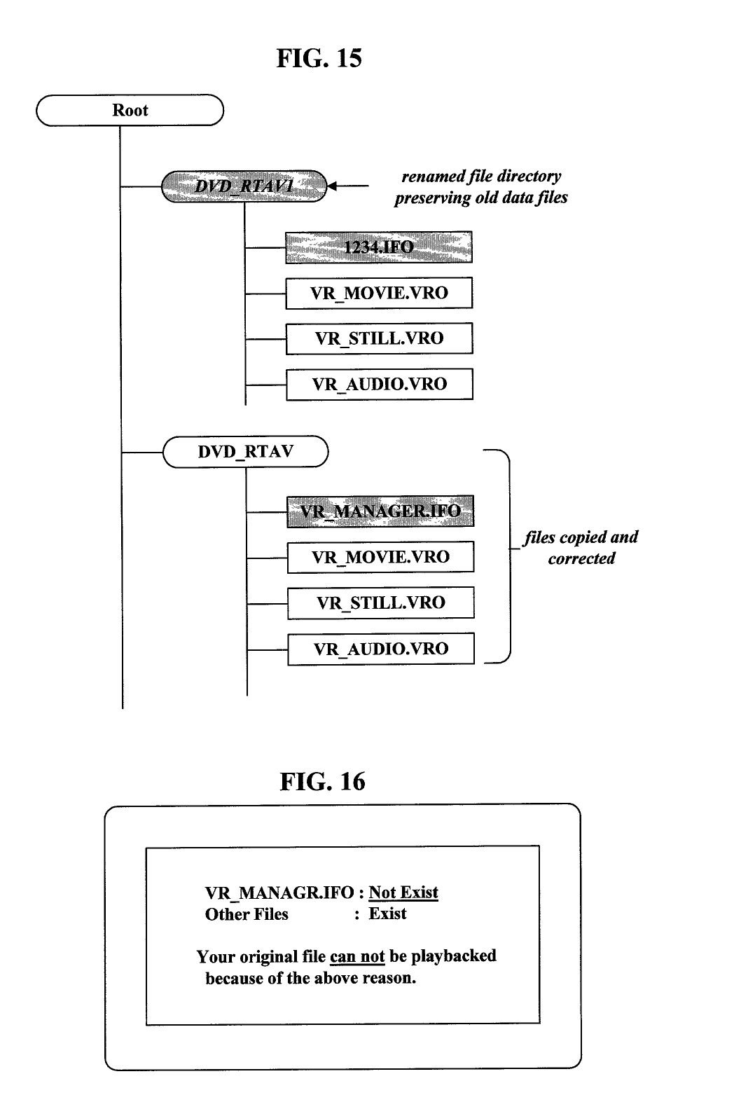

After data recording is completed, the file structure formed in the rewritable disk results in the scheme shown in FIG. 15. The playback is requested later for the rewritable disk corrected as above, the files under the directory ‘DVD_RTAV’ would be reproduced normally.

In the above file system checking procedure, if the pre-defined directory ‘DVD_RTAV’ is not found, the VDR unit 3 searches for data stream files whose names are pre-defined, that is, ‘VR_MANAGER.IFO’, ‘VR_MOVIE.VRO’, and so forth. Then if at least one file pre-defined in the standard is discovered, the VDR unit 3 creates standard directory ‘DVD_RTAV’ and copies all files under a directory containing the discovered one or more standard files into the created standard directory ‘DVD_RTAV’.

In the above file system checking procedure, it is also examined whether data recording information written in the file ‘VR MANAGER.IFO’ is in accordance with the recorded files under the directory ‘DVD RTAV’.

For example, In case that three bit flags are defined in the file ‘VR MANAGER.IFO’ for each data stream file, if bit flags are all marked as ‘1’ to indicate that all data stream files exist, however, either of the data files ‘VR MOVIE.VRO’, ‘VR_AUDIO.VRO’, and ‘VR_STILL.VRO’ is not found, then the VDR unit 3 conducts correction operation explained above.

To correct such a fault, the VDR unit 3 renames the directory ‘DVD_RTAV’ to an arbitrary non-standard name, creates the directory ‘DVD_RTAV’, copies all files under the renamed directory into the created directory ‘DVD_RTAV’, and corrects the discordance between information written in the file ‘VR_MANAGER.IFO’ and the existing data files by creating or deleting a necessary data stream file to meet the information written in the file ‘VR_MANAGER.IFO’ or modifying an appropriate bit flag.

The file system checking procedure is also conducted when a disk playback is requested. If the file structure of a rewritable disk inserted to be playbacked is against standard file system, the VDR unit 3 outputs a message informing that disk reproduction is impossible and explaining the reason. FIG. 16 is an example of a message window provided when there is no essential file ‘VR_MANAGER.IFO’.

The file managing method for real-time data file according to the present invention notifies a user of the reason why disk reproduction fails and corrects wrong file scheme, if wanted, drawn up in a rewritable disk when a file containing real-time data stream is requested to be recorded, thereby preventing reproduction failure which would be caused from inadequate file name or directory.

The invention may be embodied in other specific forms without departing from the sprit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A file managing method in reproducing a rewritable disk, comprising the steps of:
(a) checking the file names and/or directories of files written in the rewritable disk; and
(b) providing a message indicating that reproduction is impossible when the file names and/or directories are against a standard file scheme pre-specified for a disk containing real-time data.

2. The method set forth in claim 1, wherein the reason why the reproduction is impossible is contained in said message.

3. The method set forth in claim 1, wherein said steps (a) and (b) are conducted when the reproduction is requested.

4. A file managing method in recording a data stream in a rewritable disk, comprising the steps of:
(a) checking a file name and/or directory of the file requested to be recorded in the rewritable disk; and
(b) providing a message indicating that reproduction would fail later if recorded as requested when the file name and/or the directory is against a standard file scheme pre-specified for a disk containing real-time data file.

5. The method set forth in claim 4, further comprising the step of recording received data as requested if the request of record is received again after the message being provided.

6. The method set forth in claim 4, further comprising the step of deleting information received when the file record is requested if the request of record is cancelled after the message being provided.

7. The method set forth in claim 4, wherein the reason why the later reproduction would fail is contained in said message.

8. A method conducted in a computer for managing files written in a rewritable disk, comprising the steps of:
(a) checking the file type if the file is requested to be renamed or moved; and
(b) providing a message indicating that disk reproduction would be impossible after the file is renamed or moved, if the file type is one among pre-specified file types.

9. The method set forth in claim 8, further comprising the step of renaming or moving the file as requested, if the requested file operation is demanded again after the message being provided.

10. The method set forth in claim 8, wherein one of the pre-specified file types is indicative of a file containing real-time data.

11. The method set forth in claim 8, wherein the pre-specified file types are designated by means of file names defined in a file system standardized for a rewritable disk containing real-time data stream.

12. The method set forth in claim 8, said step (a) refers to a 1-byte type field written in a table of information control block (ICB) tag contained in a file entry addressed by an ICB field of a file identifier descriptor.

13. A method conducted in a computer for managing files written in a rewritable disk, comprising the steps of:
(a) checking the types of all files under a directory if the directory is requested to be renamed; and
(b) providing a message indicating that disk reproduction would be impossible after the directory is renamed, if the type of at least a file under the directory is one among pre-specified file types.

14. The method set forth in claim 13, further comprising the step of renaming the directory as requested, if the requested operation is demanded again after the message being provided.

15. A file managing method in recording data stream in a rewritable disk, comprising the steps of:
(a) checking whether or not a file structure formed in the rewritable disk conforms to a standard file system pre-specified for a disk containing real-time data stream;
(b) correcting the file structure of the rewritable disk if the file structure is against the standard file system; and
(c) writing input data stream in a data file belonging to the corrected file structure.

16. The method set forth in claim 15, wherein said step (a) determines that the file structure is against the standard file system if a directory pre-defined in the standard file system is not found.

17. The method set forth in claim 15, wherein said step (a) determines that the file structure is against the standard file system if the file name of a data file containing real-time data stream is different from the file name predefined in the standard file system.

18. The method set forth in claim 15, wherein said step (a) determines that the file structure is against the standard file system if the file recording information written in a navigation file does not accord with existing data stream files.

19. The method set forth in claim 15, wherein said step (b) copies the file structure before correction, and makes the copied file structure be distinguishable from the corrected file structure.

20. The method set forth in claim 15, wherein said step (b) outputs a message asking whether or not the requested recording operation is proceeded if the file structure is against the standard file scheme, and corrects the file structure of the rewritable disk if the requested recording operation is demanded again.
